(19) United States
(12) Patent Application Publication
(10) Pub. No.: US 2007/0053203 A1
(43) Pub. Date: Mar. 8, 2007

(54) Illumination device

(76) Inventor: Morton Graham, Lancashire (GB)

Correspondence Address: Gauthier & Connors LLP, Suite 3300, 225 Franklin Street, Boston, MA, 02110, US

(21) Appl. No.: 11/527,227

(22) Filed: Sep. 26, 2006

Related U.S. Application Data
(63) Continuation of application No. PCT/GB05/01122, filed on Mar. 16, 2005.

(30) Foreign Application Priority Data
Mar. 27, 2004 (GB) GB0406923.3

(51) Int. Cl. F21V 5/00

(52) U.S. Cl. 362/559

(57) ABSTRACT

An illumination device comprising an elongate rod (10) of a transparent acrylic material mounted on a base (11) in which is housed an array of LED's (15) which illuminate directly a lower end face of the rod (10) so that light is passed along the rod, and a conical or otherwise shaped reflecting surface (12) at the opposite end of the rod (10) and disposed obliquely thus to reflect light outwardly in a direction generally transverse to the longitudinal axis of the rod. A translucent or opaque tube (22) may be disposed around the rod other than in the upper end region thereof. The device may serve as a road hazard light, a garden path light or a table, standard or wall light.

THIS INVENTION relates to illumination devices which may be used for temporary or permanent interior or exterior illumination. In one application, such a device may serve as a road hazard light to be used by drivers of vehicles when stopped at the side of the road. Such hazard warning devices are known in the form of flares or lamps incorporating bulb, lens and/or reflector and battery, or alternatively reflective devices visible to the drivers of oncoming vehicles. Luminaires incorporating a battery and incandescent bulb are sometimes unreliable and may not be in an operative condition when required.

An object of the present invention is to provide an illumination device, particularly for this purpose, which is more reliable, compact and lightweight.

According to the present invention there is provided an illumination device comprising an elongate, low absorbent, transparent body, a light source disposed so as to illuminate directly an end face of the transparent body, the body having a reflecting surface disposed obliquely to said end face of the body thus to reflect light outwardly of the body generally transversely thereto.

The light source may incorporate at least one LED.

The transparent body may be at least partially contained within a tubular body having a translucent or transparent wall portion.

The transparent body may act as a leaky wave guide such that light entering said end face of the transparent body is allowed to diffuse outwardly of the transparent body transversely thereto.

The light source may comprise an array of LED's disposed normal to the longitudinal axis of the transparent body.

The LED's may be of the lensed type.

The reflecting surface may be a totally reflecting surface formed by a conical recess in the material of the transparent body at an end thereof opposite said end face.

The conical recess may have a reflecting medium applied thereto.

The reflecting surface may be formed by a concave recess in the material of the transparent body at an end thereof opposite said end face.

The reflecting surface may be formed by a flat surface in the material of the transparent body at an end thereof opposite said end face.

An air gap may exist between the transparent body and the reflecting surface.

An air gap may exist between the translucent body and the tubular body.

The LED's and a power supply therefor may be contained within the tubular body.

The transparent body may be an elongate rod of circular cross section and of an acrylic material.

The tubular body may be of circular cross section.

The tubular body may be of a self-coloured and translucent acrylic material.

The light source may include means for illumination in an intermittent flashing or pulsing mode.

A protective cover may be provided on the transparent body, covering the reflecting surface.

The transparent body may be mounted on a base having a shape such as to ensure that the transparent body is maintained substantially upright when the base is placed upon a generally horizontal surface.

The transparent body may be removeably mounted on the base.

The transparent body may be mounted on a base adapted to be attached to a fixed surface.

Embodiments of the invention will now be described, by way of example only, with reference to the accompanying drawings in which

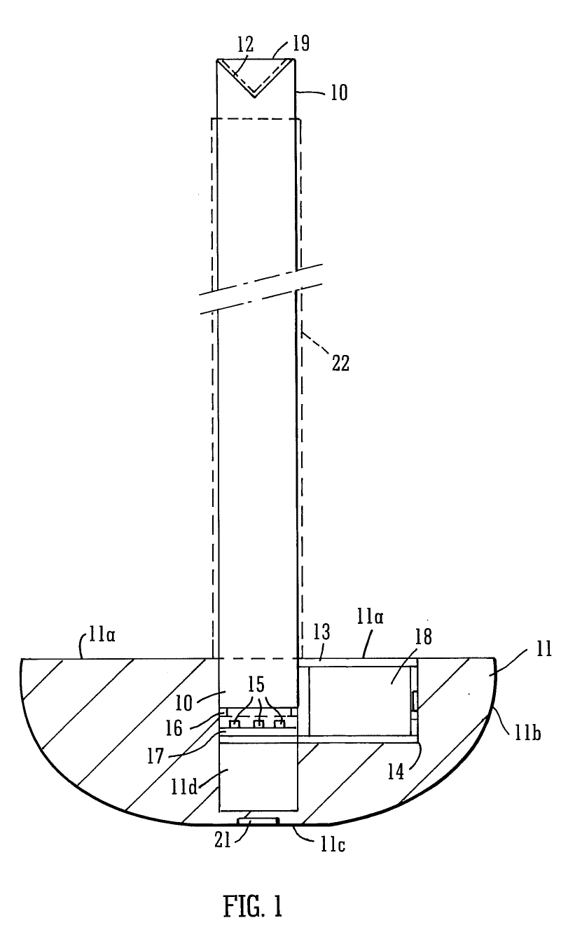

FIG. 1 schematically illustrates an illumination device made in accordance with a first embodiment;

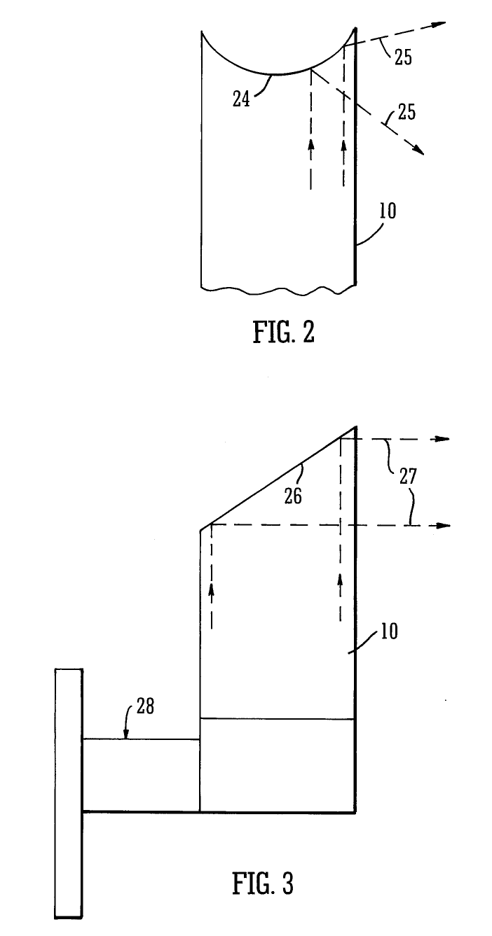

FIG. 2 schematically illustrates a part of such a device in accordance with a second embodiment; and

FIG. 3 schematically illustrates a part of such a device in accordance with a third embodiment.

Referring now to FIG. 1, there is provided an elongate body in the form of a transparent rod 10 preferably of polymethylmethacrylate, of some 20 mm in diameter and some 300 mm in length, and produced preferably by extrusion or injection moulding to have as smooth and unblemished a surface as possible.

The rod 10 is removably mounted in a recess on a resilient base 11 having a generally flat upper surface 11a and a convex or generally hemispherical lower surface 11b with a centrally located flat region 11c. Thus, when placed on the ground, the base 11 maintains the rod 10 substantially upright. The base 11 is to be self-righting if tipped over and is thus of a material having greater mass than that of the rod 10, or alternatively a weight 11d may be disposed within a lowermost region of the base.

The rod 10 is supported in the base 11 by an annular ledge 16.

At the top of the acrylic rod 10 an inverted conical recess 12 is milled out of the material of the rod and polished, or solvent or heat treated, to give a smooth finish and to provide a 45° total reflecting surface, with the deepest point on the longitudinal axis of the rod. The apex of the conical recess should be as sharp as possible for complete light deflection. The lower end of the rod should also be polished or treated to have a smooth surface.

Mounted on top of the rod 10 may be a cover 19 having an inverted conical shape which resides in the recess 12. If required, the cover 19 may have a reflecting lower surface which, however, should have no contact with the reflecting surface of the recess 12. Thus, there may be a slight air gap between the surface of the recess 12 and that of the reflective cover.

Within the base 11 beneath the rod 10 there is housed an array of lensed LED's 15 on a printed circuit board 17, and a battery 18 connected thereto by a lead 14. The LED's may be some eight in number disposed in a ring around the longitudinal axis of the rod 10 while a further LED may be located on the axis.

A waterproof seal 13 is removably located above the battery 18 for replacement of the latter when required.

A sprung switch or mercury switch 21 may be disposed on the underside of the base 11 thus automatically to energise the LED's 15 when the base is placed upon the ground. When the LED's 15 are energised, the light therefrom is predominantly directed longitudinally through the transparent rod 10 by substantially total internal reflection and then deflected outwards radially by the reflecting surface of the recess 12 at the top of the rod 10 thus to pass outwardly, generally transversely to the longitudinal axis of the rod, all around the rod. A concentrated beam of bright light may therefore be seen in the upper region of the rod 10. The beam diverges upwardly at an angle in the region of 15° from the horizontal.

If the material of the transparent rod 10 has surface imperfections so as to be outwardly diffusing to some extent, thus acting as a leaky wave guide, then the remainder of the wall of the rod will also be illuminated, though with much less intensity than the reflected light.

Control circuitry (not shown) for the LED's 15 may optionally provide for them to be illuminated intermittently in a flashing or pulsed mode, for example, by the use of a bimetallic contact or flip-flop circuit, a changeover switch 23 being provided, for example in the battery housing, for selection of a continuous, flashing or pulsing mode. Alternatively, some of the LED's may flash while others are illuminated continuously. If the LED's are pulsed to give a “flicker” effect, this will also prolong battery life. The LED's may be selected to emit coloured light such as red or blue and may flash alternately if required, for example, by the Police service thus avoiding the need for rotating mirrored lights conventionally used by the Police and other emergency services.

As an additional feature, a tubular sleeve 22 preferably made of a transparent acrylic material which may be self-coloured, for example, red, may be positioned over the rod 10 to protect the rod from atmospheric contamination and other damage from immediate contact to its surfaces. In the example illustrated, the tube 22 is shorter than the rod 10 to avoid interference with the light reflected from the recess 12, but instead it may cover the entire length of the rod with a protective cap at the top of the tube 22 also covering the top of the rod.

The translucent or transparent tube 22 will serve to diffuse any light diffused through the wall of the rod 10 so that the visual effect will be that of an upright member displaying a “watery” light but with a main beam appearing at its upper end.

If the top of the rod 10 is exposed then some light will also be visible directly above the rod.

The battery 18 may be rechargeable and may have a lead connected thereto which may be plugged into a cigar lighter socket in a vehicle, or, until deployed, permanently connected to the vehicle battery thus remaining in a fully charged condition ready for use.

The automatic switch 21 may be replaced by a manual switch if preferred.

The device is equally effective when operated without the tube or sleeve 22, when the rod is completely transparent but gives out light almost as if it were a liquid light within a water tube. Equally it is most effective without the protective and reflective cone or cap 19. It will be appreciated that by selecting the oblique angle of the conical recess 12, the depth and intensity of the beam from the upper end region of the rod 10 may be determined accordingly. While a 45° angle to the longitudinal axis is considered the optimum, nevertheless the beam may be deflected in other directions by appropriate selection of the angle locally or totally.

Referring now to FIG. 2, the rod 10 may have a continuously curved, concave or bowl-shaped reflecting surface 24. Light travelling up the rod 10 is thus reflected outwardly and downwardly. Dotted lines 25 illustrate this schematically although owing to the substantially total internal reflection of light within the rod 10, photons are deflected by the surface 24 in many different directions. However, the curvature of the surface 24 generates a beam of light which is predominantly in an outwards and downwards direction. Thus such a device may serve as a down lighter for garden path lighting, or as table lamp or standard lamp. In this example, as well as in the embodiment of FIG. 1, the circuit board 17 may have a highly reflective silver or white upper surface to ensure maximum internal reflection of light within the rod 10.

Referring now to FIG. 3, the rod 10 may have a single flat reflecting surface 26 disposed at 45° to the longitudinal axis of the rod. The dotted lines 27 again schematically illustrate a horizontal beam emitted from the rod in a single direction. As shown, such a device may serve as a wall-mounted lamp attached by a bracket 28 to a wall of a room, or an exterior wall. If required the rod may be rotatably adjustable to determine the direction of the beam.

A translucent or transparent tube similar to tube 22 may be incorporated in the embodiments of FIGS. 2 and 3.

In all embodiments, the tube 22 may be opaque to prevent light from being emitted other than in the upper end and region of the device.

1. An illumination device comprising an elongate, low absorbent, transparent body, a light source disposed so as to, illuminate directly an end face of the transparent body, the body having a reflecting surface disposed obliquely to said end face of the body thus to reflect light outwardly of the body generally transversely thereto.

2. An illumination device according to claim 1 wherein the light source incorporates at least one LED.

3. An illumination device according to claim 1 wherein the transparent body is at least partially contained within a tubular body having a translucent or transparent wall portion.

4. An illumination device according to claim 1 wherein the transparent body acts as a leaky wave guide such that light entering said end face of the body is diffused outwardly of the body transversely thereto.

5. An illumination device according to claim 2 wherein the light source comprises an array of LED's disposed normal to the longitudinal axis of the transparent body.

6. An illumination device according to claim 5 wherein the LED's are of the lensed type.

7. An illumination device according to claim 1 wherein the reflecting surface is a totally reflecting surface formed by a conical recess in the material of the transparent body at an end thereof opposite said end face.

8. An illumination device according to claim 7 wherein the comical recess has a reflective medium applied thereto.

9. An illumination device according to claim 1 wherein the reflecting surface is formed by a concave recess in the material of the transparent body at an end thereof opposite said end face.

10. An illumination device according to claim 1 wherein the reflecting surface is formed by a flat surface in the material of the transparent body at an end thereof opposite said end face.

11. An illumination device according to claim 1 wherein an air gap exists between the transparent body and the reflecting surface.

12. An illumination device according to claim 1 wherein an air gap exists between the translucent body and the tubular body.

13. An illumination device according to claims 3 and 5 wherein the LED'S and the power supply therefor are contained within the tubular body.

14. An illumination device according to claim 1 wherein the transparent body is an elongate rod of circular cross sections.

15. An illumination device according to claim 3 wherein the tubular body is of a circular cross section.

16. An illumination device according to claim 3 wherein the tubular body is of a self coloured and translucent acrylic material.

17. An illumination device according to claim 1 wherein the light source includes means for illumination in an intermittent flashing or pulsing mode.

18. An illumination device according to claim 1 including a protective cover provided on the transparent body, covering an external face of the reflecting surface thereof.

19. An illumination device according to claim 1 wherein the transparent body is mounted on a base having a shape such as to ensure that the transparent body is maintained substantially upright when the base is placed upon a generally horizontal surface.

20. An illumination device according to claim 19 wherein the transparent body is removably mounted on the base.

21. An illumination, device according to claim 1 wherein the transparent body is mounted on a base adapted to be attached to a fixed surface.

22. An illumination device according to claim 19 wherein the transparent body is mounted on the base, thus to be angularly adjustable relative thereto to determine the direction in which light is reflected by the reflecting surface.
